(19) United States
(12) Patent Application Publication
(10) Pub. No.: US 2021/0292138 A1
(43) Pub. Date: Sep. 23, 2021

(54) HOISTING CRANE FOR USE ON AN OFFSHORE VESSEL AND METHOD OF OPERATION

(71) Applicant: Itrec B.V., SCHIEDAM (NL)

(72) Inventors: Cornelis Martinus VAN VELUW, SCHIEDAM (NL); Joop ROODENBURG, SCHIEDAM (NL)

(73) Assignee: Itrec B.V., SCHIEDAM (NL)

(21) Appl. No.: 16/612,228

(22) PCT Filed: May 9, 2018
(86) PCT No.: PCT/NL2018/050309

§ 371 Date: Nov. 8, 2019

(30) Foreign Application Priority Data
May 12, 2017 (NL) 2018912

(51) Int. Cl. B66C 23/52; B66C 23/64; B66C 23/82; B66C 23/18; F03D 13/10; F03D 13/25

(52) U.S. Cl. CPC B66C 23/52; B66C 23/64; B66C 23/82; B66C 2700/0321; F03D 13/10; F03D 13/25; F05B 2230/6102; B66C 23/185

(57) ABSTRACT

A hoisting crane for use on an offshore vessel, such a vessel and a method for hoisting an offshore wind turbine component wherein use is made of such a crane and/or vessel. The hoisting crane includes a base structure, a superstructure, a boom having a longitudinal axis and a length of 80-200 meters. The boom includes a proximal portion connected to the boom connection member, formed integral via a joint structure with a single distal leg, wherein the length of the distal leg between the joint and the boom head structure exceeds 30 meters.

The present invention relates to a hoisting crane for use on an offshore vessel, such a vessel and a method for hoisting an offshore wind turbine component wherein use is made of such a crane and/or vessel.

The invention relates in particular to a hoisting crane for use in handling of one or more offshore wind turbine components, e.g. the nacelle and/or one or more components that are housed in a nacelle and/or mounted on the nacelle, e.g. gearbox, generator, hub and/or blades, of an offshore wind turbine, e.g. for installation and/or maintenance of an offshore wind turbine.

In the field of offshore wind turbines the need exists for the handling by a tall crane of components “at the height of the nacelle”, which includes for example the handling of the nacelle itself, and/or one or more components that are housed in a nacelle and/or mounted on the nacelle, e.g. gearbox, generator, hub and/or blades, of an offshore wind turbine.

Current designs of offshore wind turbines propose or already have the nacelle at a height of more than 100 meters above sea level, e.g. at 120 meters or more. Therefore the handling of such components requires a very tall crane. Also the mass of such components can be significant, in the range of 5-150 tons, with components like the generator and gearbox being in the upper portion of this range.

In a common approach, the vessel is a jack-up vessel that is positioned close to the wind turbine and then the legs are extended and the vessel is lifted, at least in part but mostly entirely, to provide a stabilized situation for the crane operation.

It is noted that the invention is primarily envisaged for the offshore wind turbine field, so for maintenance, and also for installation and/or decommission of wind turbines. However the invention may also be of use in other offshore applications, like oil & gas related jobs, civil engineering operations, etc.

Hoisting cranes are known, comprising:
a base structure adapted to be mounted on the vessel;
a superstructure mounted to the base structure, being provided with:
   a top cable guide at a top thereof; and
   a boom connection member;
a boom having a longitudinal axis A and a length of 80-200 meters;
a boom head structure provided at a tip end of the boom;
a luffing device for pivoting the boom up and down, comprising a luffing winch and a variable length luffing system; the variable length luffing system extending from the luffing winch via the top cable guide to the boom head structure;
a hoisting device for hoisting a load, comprising a hoisting winch and an associated hoisting cable; the hoisting cable extending from the hoisting winch to a main hoist cable guide on the boom head structure.

It is known to provide a so-called singe lattice boom. Alternatively, A-frame lattice booms are known which have generally the shape of an A with two boom legs connected to the boom connection member. In such embodiments, the boom connection member comprises a left-hand connector and a right-hand hand connector at a mutual distance of each other, together defining a horizontal pivot axis. The boom has an inner end connected to the left-hand connector and to the right-hand connector of the boom connection member, so that the boom can be pivoted up and down about the horizontal pivot axis which is perpendicular to the longitudinal axis of a boom.

According to the present invention, the boom comprises a proximal portion connected to the boom connection member, formed integral via a joint structure with a single distal leg, wherein the length of the distal leg between the joint and the boom head structure exceeds 30 meters. Hence, the boom has a general Y-shape with two boom legs connected to the boom connection member, formed integral with a distal leg.

In particular, the proximal portion of the boom comprises a left-hand boom leg and a right-hand boom leg of equal length extending between the joint structure and the left-hand connector of the boom connection member and the right-hand connector of the boom connection member, respectively, such that the left-hand boom leg and the right-hand boom leg converge towards each other in the direction of the joint structure, forming a clearance therebetween of an essentially triangular shape seen in a plane defined by the substantially horizontal pivot axis and the longitudinal axis of the boom. Each of the two boom legs comprises a hollow box structure with a top and bottom face and an outer and an inner side face, wherein the inner side faces of the left-hand and right-hand boom legs face the clearance between the boom legs. the single distal leg having a hollow box structure with a top and bottom face and two side faces. At the joint structure the width between the side faces of the single distal leg is at least 70% of the width between the outer side faces of the boom legs of the proximal portion.

The main hoist of a crane determines the main hoist capacity of the crane. The main hoist and the connection to the luffing system are provided at essentially the same location along the longitudinal axis of the boom. In addition thereto it is possible to provide additional hoists, e.g. a whiphoist at a location distal from the location of the connection to the luffing system. Such additional hoists have a lower hoist capacity than the main hoist.

Particular advantages of this design are its strength resulting from the clearance between the boom legs, its possibility to elongate/shorten the boom relatively easily, and the compact tip end of the boom which is advantageous for the transmittance of forces, in combination with adequate hoist characteristics.

In embodiments, the ratio between the proximal portion and the distal leg is generally between 1:1 and 3:1, advantageously between 1:1 and 2:1. Such a ratio provides an optimum strength.

In embodiments, the hollow box structure comprises a planar latticed trusses at the top and/or bottom face, and preferably a lattice web at the side face. Alternatively, it is conceivable that the hollow box structure comprises one or more steel plates. Possibly, the hollow box structure is embodied such as disclosed in EP2274225 of the same applicant. The hollow box structure is hollow, but it is conceivable that at head ends (of parts) thereof transverse girders are provided.

In embodiments, at the joint structure the outer side faces of the boom legs of the proximal portion are aligned with the side faces of the distal leg. Hence, the side faces run over into each other. This provides a very stable boom.

In embodiments, the hollow box structure of the single distal leg comprises:
an upper and lower planar latticed truss provided parallel to a plane defined by the substantially horizontal pivot axis and the longitudinal axis of the boom, each with two chords between which lacing elements extend;
a first and second lattice web, each connected to one of the chords of the upper planar latticed truss and one of the chords of the lower planar latticed truss.

In embodiments, the side faces of the single distal leg are essentially parallel.

In embodiments, the hollow box structure of each of the two boom legs comprises:
an upper and lower planar latticed truss provided parallel to a plane defined by the substantially horizontal pivot axis and the longitudinal axis of the boom, each with two chords between which lacing elements extend;
an outside and an inside lattice web;
   wherein the inside lattice webs of the left-hand and right-hand boom legs face the clearance between the boom legs;
   the outside lattice web being connected to an outside chord of the upper planar latticed truss and an outside chord of the lower planar latticed truss; and the inside lattice web being connected to an inside chord of the upper planar latticed truss and an inside chord of the lower planar latticed truss.

In embodiments, the hoisting crane, further comprising an annular bearing structure, wherein the superstructure is moveably mounted to the base structure via the bearing structure to allow the superstructure with the boom connection member to revolve about a vertical revolving axis relative to the base structure. Hence, this results in a revolving hoist crane.

In embodiments, the proximal portion further comprises one or more connection members oriented parallel to the substantially horizontal pivot axis, connecting the two boom legs in the clearance between them. Such a connection member can be provided relatively close to the horizontal pivot axis. There is a relatively large design freedom for such a connection member, also referred to as cross beam.

In embodiments, the luffing winch is mounted to a foot portion of the superstructure, opposite the boom connection member. This is advantageous in view of forming a counterweight. Advantageously, also the main hoist winch is mounted here, adjacent the luffing winch.

In embodiments, the hoisting crane further comprising a whiphoist, mounted to the boom head structure.

In embodiments, the superstructure comprises an open frame, also known as “gantry”. This is in particular advantageous when the hoisting crane is used as an ‘around the leg’-crane around a jack-up leg.

The invention further relates to an offshore vessel for use in handling of one or more offshore wind turbine components, e.g. the nacelle and/or one or more components that are housed in a nacelle and/or mounted on the nacelle, e.g. hub and/or blades, of an offshore wind turbine, e.g. for installation and/or maintenance of an offshore wind turbine, wherein the vessel is provided with such a hoisting crane.

In embodiments, the vessel is a marine jack-up type crane vessel comprising:
a hull with a deck,
a plurality of jack-up legs, each of which legs is movable in a vertical direction with respect to the hull,
a plurality of generally vertical leg openings extending through the hull, and wherein the jack-up legs extend through the hull via one of said vertical leg openings;
a plurality of jack-up housings provided on deck and housing the vertical leg openings, and wherein the base structure is formed integral with a jack-up housing.

The invention further relates to a method for hoisting an offshore wind turbine component, e.g. the nacelle and/or one or more components that are housed in a nacelle and/or mounted on the nacelle, e.g. gearbox, generator, hub and/or blades, of an offshore wind turbine, e.g. for installation and/or maintenance of an offshore wind turbine, wherein use is made of such a crane and/or a vessel.

A second aspect of the present invention relates to a marine jack-up type crane vessel comprising:
a hull having a bow and a stern and a port side and a starboard side with a deck,
a plurality of jack-up legs, each of which legs is movable in a vertical direction with respect to the hull,
a plurality of generally vertical leg openings having a center C extending through the hull, and wherein the jack-up legs extend through the hull via one of said vertical leg openings;
an around the leg-type hoisting crane comprising
   a base structure around a jack-up leg;
   an annular bearing structure mounted to the base structure;
   a superstructure moveably mounted to the base structure via the bearing structure to allow the superstructure with the boom connection member to revolve about a vertical revolving axis R1 relative to the base structure; the superstructure comprising a boom connection member;
   a boom connected to the boom connection member;

wherein the vertical revolving axis R1 is closer to the port side or starboard side of the vessel than the center C of the vertical leg opening of the jack-up housing onto which the hoisting crane is mounted.

The advantage of such an arrangement that the free deck space that is available is enlarged.

In embodiments even more free deck space is created by providing the vertical revolving axis R1 closer to the bow/stern of the vessel than the center C of the vertical leg opening of the jack-up housing onto which the hoisting crane is mounted.

The invention will be elucidated further in relation to the drawings, in which:

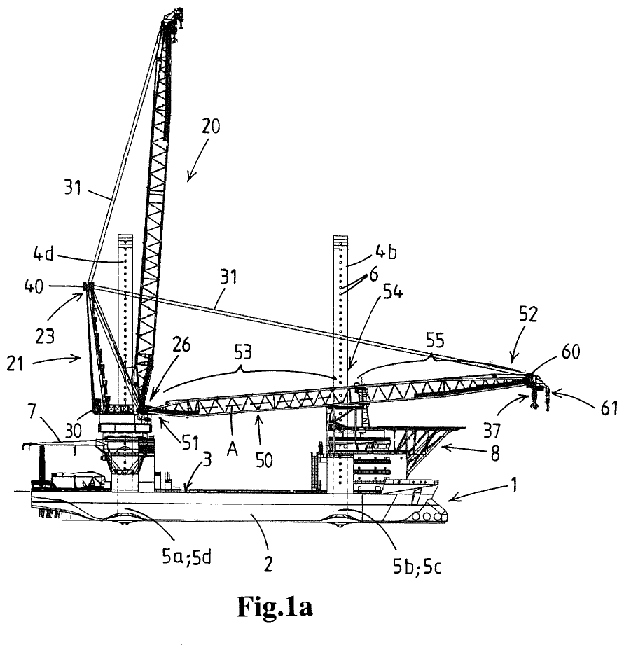

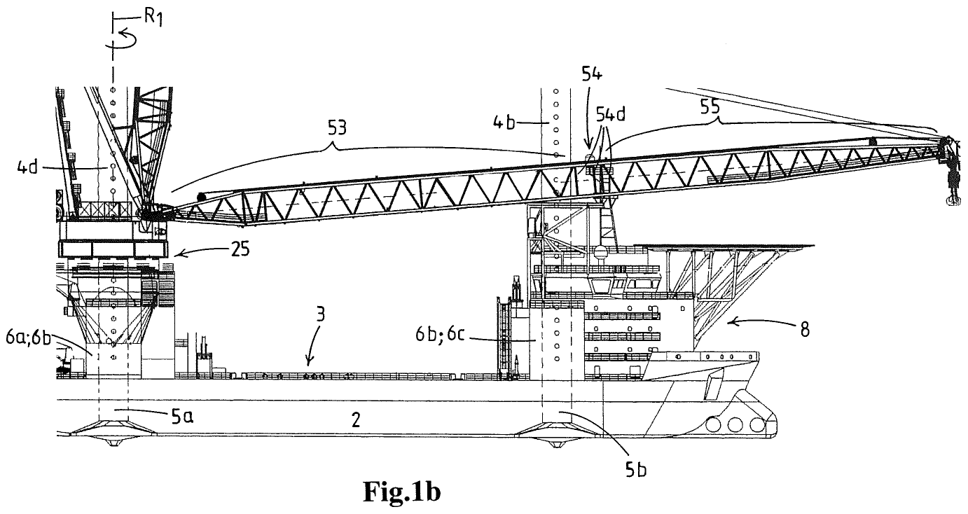

FIG. 1a represents a side view of a jack-up type marine vessel with a hoisting crane according to the invention;

FIG. 1b represents a detail of the crane of FIG. 1a,

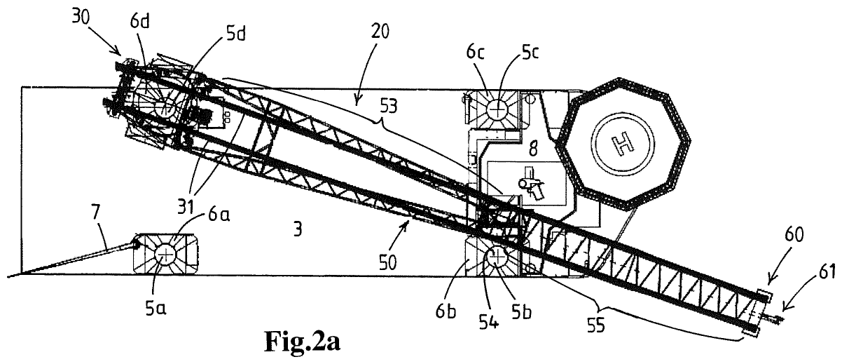

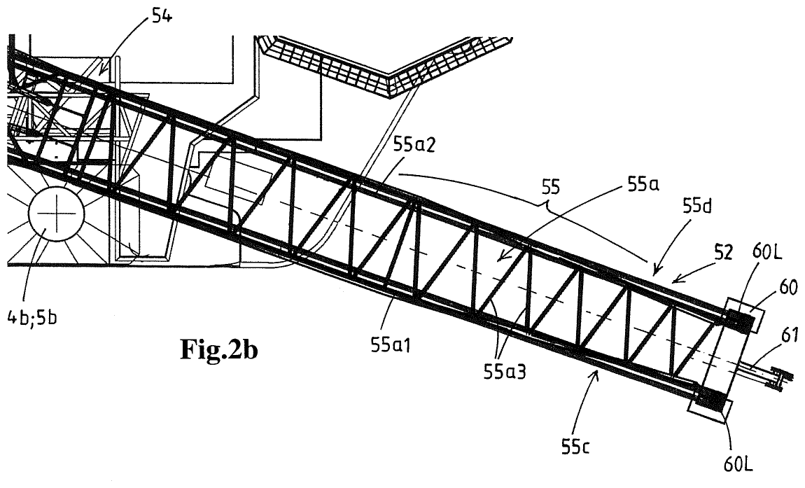

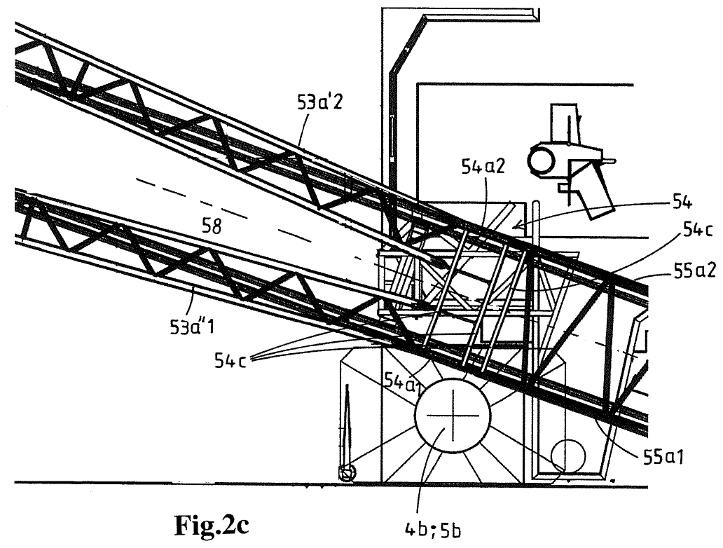

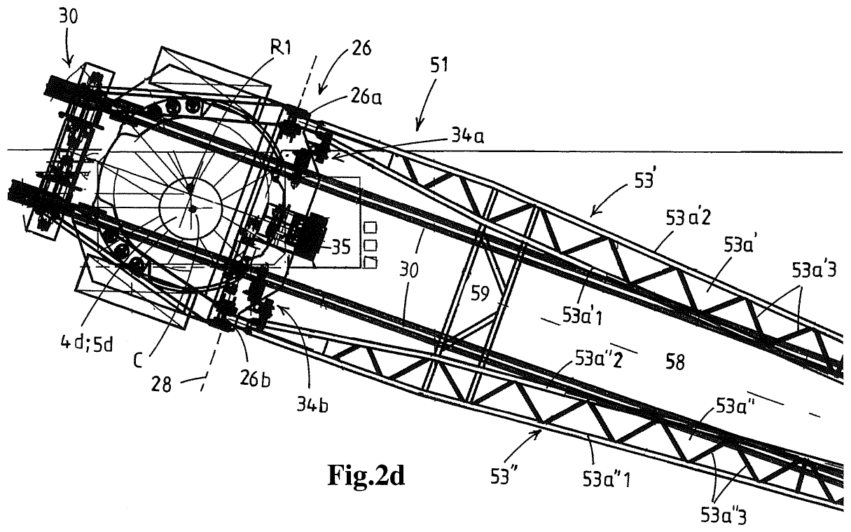

FIG. 2a represents a top view of the jack-up type marine vessel of FIG. 1a;

FIG. 2b represents a detailed top view of the distal leg portion of the crane of FIG. 2a;

FIG. 2c represents a detailed top view of the joint of the crane of FIG. 2a;

FIG. 2d represents a detailed top view of the proximal portion of the boom of FIG. 2a;

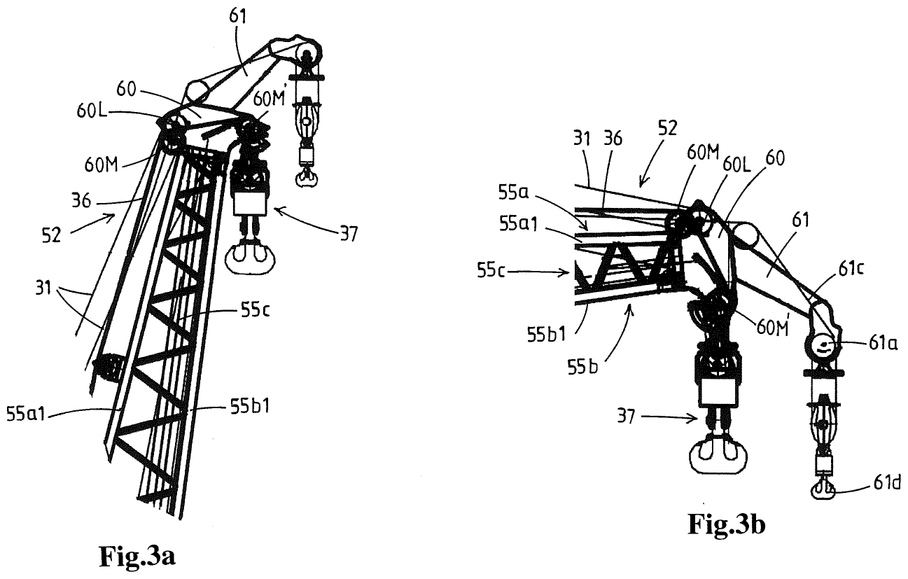

FIG. 3a represents a detailed side view of the boom head structure of FIG. 1a in a raised position of the boom;

FIG. 3b represents a detailed side view of the boom head structure of FIG. 1a in a lowered position of the boom;

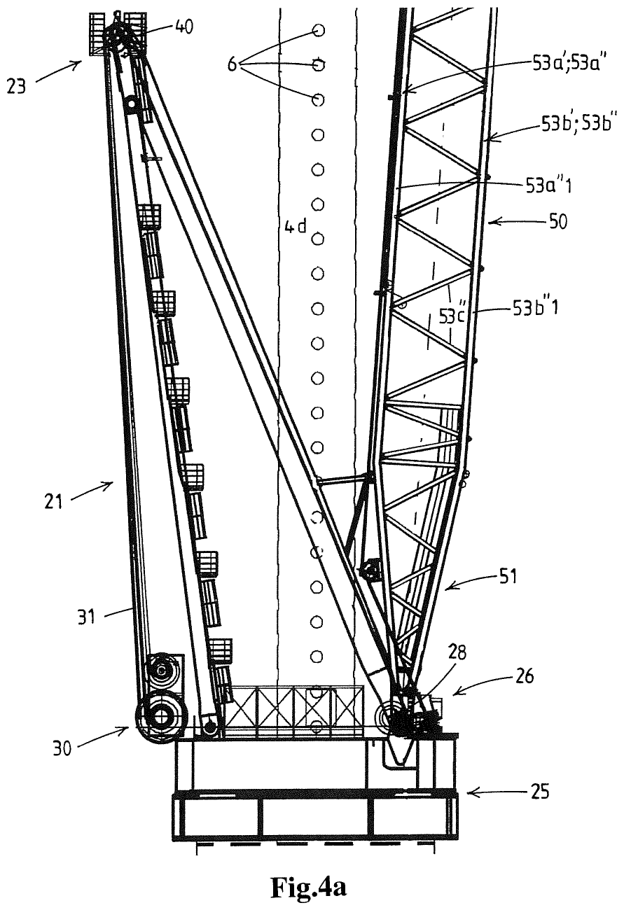

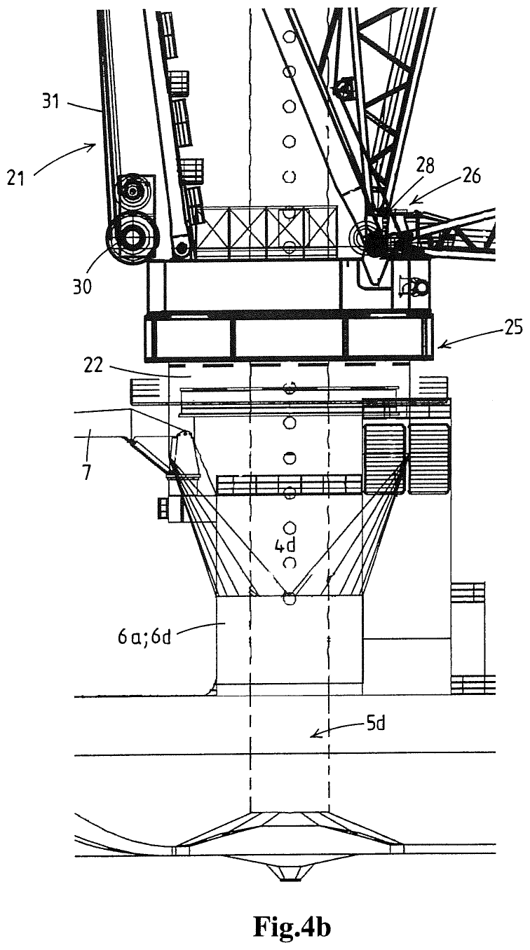

FIG. 4a represents a detailed side view of the superstructure of the crane of FIG. 1a;

FIG. 4b represents a detailed side view of the base structure of the crane of FIG. 1a;

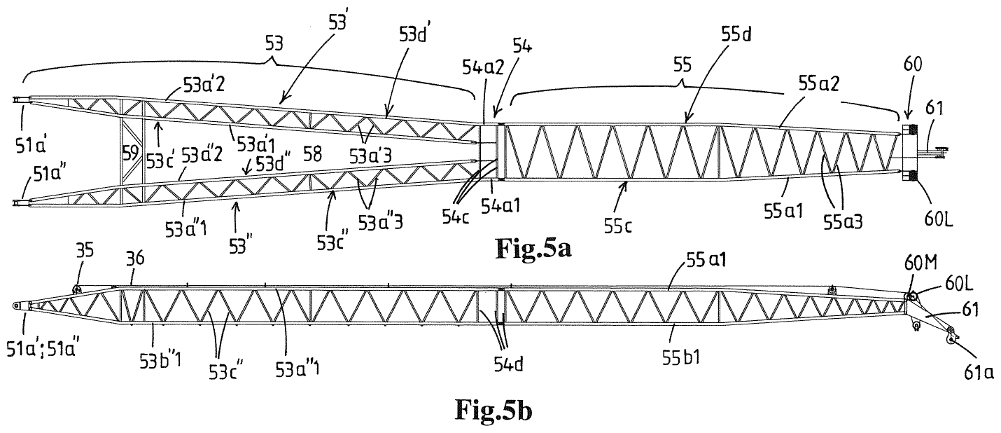

FIG. 5a represents a detailed top view of the boom of FIGS. 1a-4b;

FIG. 5b represents a detailed side view of the boom of FIGS. 1a-4b;

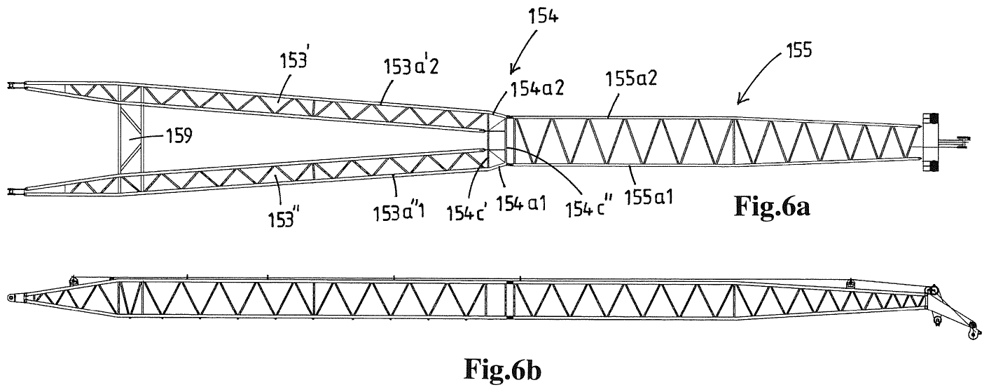

FIG. 6a represents a detailed top view of a boom according to an alternative embodiment of the invention;

FIG. 6b represents a detailed side view of the boom of FIG. 6a;

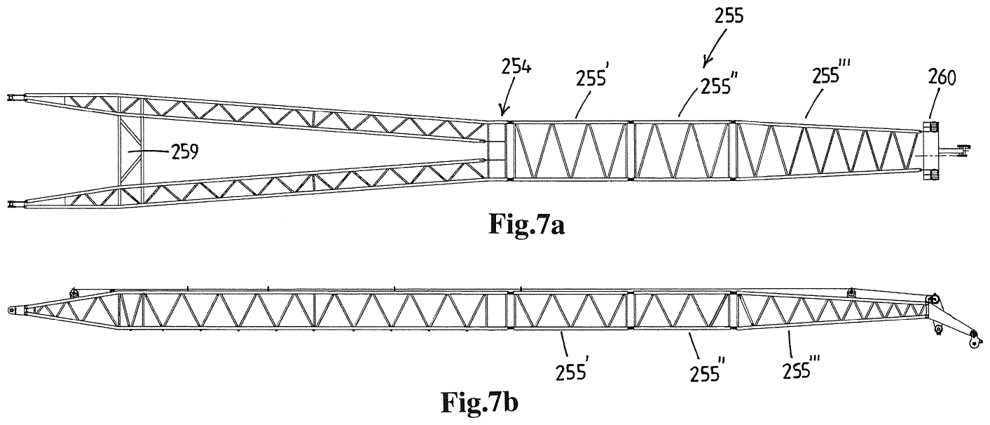

FIG. 7a represents a detailed top view of a boom according to a second alternative embodiment of the invention;

FIG. 7b represents a detailed side view of the boom of FIG. 7a.

In FIGS. 1a-4b, an exemplary jack-up type marine vessel 1 is shown, comprising a hull 2 and a plurality of generally vertical leg openings 5a, 5b, 5c, 5d through the hull. Here, the hull is embodied as a vessel. Alternatively, the hull is embodied as a barge or a platform or a semi-submersible or the like. The shown hull 2 comprises a deck 3.

The leg openings 5a-5d are spaced about the hull. In FIGS. 1a and 1b two of such openings are visible, while the vessel comprises four of such openings as visible in the top view of FIG. 2. Generally, a hull comprises 3, 4 or 6 of such openings to provide a stable jack-up type marine vessel.

A plurality of legs 4a, 4b, 4c, 4d extend through the hull 2 via the one of said vertical leg openings 5a, 5b, 5c, 5d respectively; each of which legs is movable in a vertical direction with respect to the hull. A plurality of elevating units is positioned at the vertical leg openings for changing the elevation of the hull relative to the legs, each of the elevating units being adapted to lift the hull when the legs engage the seabed. In the side view, again, only two of such legs are visible, while the vessel comprises four of such legs.

In the legs, openings 6 are visible which are able to receive pins (not visible) to fixate the hull relative to the legs.

In embodiments, the elevating units are adapted to lift the hull free of the water surface when the legs engage the seabed. It is also conceivable that the hull is semi-submersible and that the elevating units are able to position the hull partially under water when the legs engage the seabed.

In the shown embodiment, jack-up housings 6a, 6b, 6c, 6d are provided on deck 3 extending a distance above deck and housing the vertical leg openings 5a, 5b, 5c, 5d respectively, and possibly also the respective lifting units. Legs 4a, 4b, 4c, 4d respectively extend through these jack-up housings 6a-6d, as visible in the drawings.

The vessel 1 has a bow and a stern, wherein the vessel has a crew and bridge superstructure 8 at the bow of the vessel and wherein the vessel has a deck aft of said crew and bridge superstructure, and wherein a hoisting crane 20 according to the invention is mounted at the stern of the vessel, in particular around the leg 6d.

In the shown embodiment, a small crane 7 is mounted on the jack-up housing 6a. Crew and bridge structure 8, including a helicopter platform, is provided adjacent and between jack-up housings 6b, 6c.

Advantageously, not shown in the present embodiment, the crew and bridge superstructure is arranged asymmetrically at said bow of the vessel, e.g. toward the starboard side thereof, and wherein the crane is arranged asymmetrically at the stern of the vessel, opposite from the centreline of the vessel relative to the crew and bridge superstructure, e.g. toward the port side thereof.

In the shown embodiment, a base structure 22 of the hoisting crane 20 is formed integrally with jack-up housing 6d. Here, the base structure is essentially shaped as a truncated cone, having a smaller and here square-shaped cross section at the bottom end, adjacent the jack-up housing 6d, and a larger, circular cross-section at its top end, e.g. having a diameter at the top of 13-16 meters. Said base structure is structurally anchored to the hull 2 via the jack-up housing 6d, independently of the leg 5d and its elevating unit.

In the shown embodiment, an annular bearing structure 25 is mounted on the base structure 22. The annular bearing structure 25 is thus provided a distance above the deck 3 of the vessel, e.g. 20-30 meters.

A superstructure 21 of the crane is mounted to the base structure 22 around the leg 4d. Here, the superstructure 21 is moveably mounted to the base structure via the bearing structure 25 to allow the superstructure to revolve about a vertical revolving axis R1 relative to the base structure and thus around the leg 6d, independently of the leg. Such a crane-type is known in the art as an ‘around the leg-crane’.

In the shown embodiment, the center C of vertical leg opening 5d surrounded by jack-up housing 6d is indicated with the letter C. The superstructure revolves about R1, which is here closer to the port side of the vessel than the center C of the vertical leg opening of the jack-up housing onto which the hoisting crane is mounted. This is advantageous as it enlarges the available deck space. This is in particular advantageous in the shown embodiment wherein a hoisting crane having a relatively large bearing structure is used.

The superstructure 21 of the shown embodiment comprises an elongated A-shaped frame, also referred to as “gantry”. It comprises a top 23, provided with a top cable guide 40. Furthermore, the superstructure 21 comprises a boom connection member 26, which is here mounted to a foot portion of the superstructure, adjacent the bearing structure 25.

The boom connection member 26, as shown in detail in FIG. 2d, comprising a left-hand connector 26a and a right-hand hand connector 26b at a mutual distance of each other, together defining a horizontal pivot axis 28.

In the shown embodiment, the connectors 26a and 26b have a mutual distance of 10-20 meters, in particular 15 meters. Such an large mutual distance requires a larger superstructure, and, when present, a larger bearing structure. In view of the above-indicated advantage of providing the rotation axis R1 closer to the port side (or starboard side) than the center of the vertical leg opening of the jack-up housing onto which the hoisting crane is mounted, it is evident that this advantage is in particular present in this type of cranes.

The crane further comprises a boom 50 having a longitudinal axis A and a length of 80-200 meters. In particular, the boom has a length and a boom working angle range such that the tip end thereof is positionable in a position wherein a tip end is at least 100 meters above the water. The boom has an inner end 51 connected to the left-hand connector and right-hand connector of the boom connection member 26, so that the boom can be pivoted up and down about the horizontal pivot axis 28 which is perpendicular to the longitudinal axis A of a boom.

At a tip end 52 of the boom, there is provided a boom head structure 60. This is shown in detail in FIGS. 2b, 3a and 3b. In the shown embodiment, the hoisting crane 20 further comprises a whiphoist 61, mounted to the boom head structure 60. The whiphoist 61 comprises a whiphoist pulley 61a, over which a whiphoist cable 61c is guided, which supports a whiphoist hook 61d.

The crane further comprises a luffing device for pivoting the boom up and down, comprising a luffing winch 30 and a variable length luffing system 31. The variable length luffing system 31 extends from the luffing winch 30, via the top cable guide 40 to the boom head structure 60, here to pulleys 60L provided on the boom head structure 60. In the shown embodiment, as in particular visible in FIG. 2d, the luffing winch 30 is mounted to a foot portion of the superstructure, adjacent the bearing structure 25 and opposite the boom connection member 26. This is advantageous in view of the balance of forces, it serves as a counterweight to the boom and object suspended therefrom.

In the shown embodiment, the variable length luffing system 31 comprises a cable. In alternative embodiments, it is conceivable that the variable length luffing system comprises a cable and rods, e.g. tie rods, e.g. connected to the boom head structure.

The hoisting crane 20 further comprises a hoisting device for hoisting a load, comprising a hoisting winches 34a, 34b (visible in FIG. 2d) and an associated hoisting cable 36. The hoisting cable 34 extends from the hoisting winches 34a, 34b to a main hoist cable guide 60M, 60M′ on the boom head structure 60.

The hoisting winches 34a, 34b in the shown embodiment are mounted to the inner end 51 of the boom, adjacent the left-hand 26a and right-hand connector 26b of the boom connection member 26, respectively. Alternatively, the hoisting winch(es) are mounted to the superstructure, e.g. adjacent the luffing winch, or between the connectors of the boom connection member.

The hoisting cable 36 extends to an object suspension device 37, which here comprises a configuration of pulleys and yokes to be able to provide a versatile system, suitable to hoist heavy loads.

An operators cabin 35 is visible in the shown embodiment, mounted to a foot portion of the superstructure 21, adjacent the bearing structure 25 and between the left-hand 26a and right-hand connector 26b of the boom connection member 26.

According to the present invention, the boom comprises a proximal portion 53 connected to the boom connection member 26, formed integral via a joint structure 54 with a single distal leg 55, wherein the length of the distal leg between the joint structure and the boom head structure 60 exceeds 30 meters.

Hence, the overall boom length is 80-200 meters and the length of the distal leg is over 30 meters. The joint structure is a relatively short structure, having a length of 1-10, in particular 2-5 meters. The length ratio between the proximal portion and the distal leg is generally between 1:1 and 3:1, advantageously between 1:1 and 2:1. For example, for a boom length of 125 meters, the length of the proximal portion is about 65 meters and the length of the distal leg is about 55 meters.

As indicated above, the distance between the left-hand connector and the right-hand connector is advantageously 10-20 meters. At the inner end of the boom, the mutual distance between the outer side faces of the boom legs of the proximal portion essentially corresponds to this mutual distance, and is hence also between 10-20 meters. The mutual distance between the side faces of the single distal leg is preferably 5-10 meters. In an embodiment, the mutual distance between the outer side faces of the boom legs of the proximal portion is 15 meters, and the mutual distance between the side faces of the single distal leg is 7 meters.

Advantageously, the ratio between mutual distance between the outer side faces of the boom legs of the proximal portion, and the mutual distance between the side faces of the single distal leg is generally between 1.75:1 and 2.25:1.

The single distal leg 55 is shown in a detailed top view in FIG. 2b, and partially in FIGS. 3a and 3b. The single distal leg 55 has an upper planar latticed truss 55a, and lower planar latticed truss 55b, provided parallel to a plane defined by the substantially horizontal pivot axis 28 and the longitudinal axis of the boom A. The upper latticed truss 55a is provided with two chords 55a1 and 55a2, between which lacing elements 55a3 extend (FIG. 2b). The lower latticed truss 55b is provided with two chords 55b1 and 55b2 (not visible, in the top view of FIG. 2b positioned below chord 55a2), between which lacing elements extend. In FIGS. 3a and 3b, a first lattice web 55c is visible, connected to chord 55a1 of the upper planar latticed truss and chord 55b1 of the lower planar latticed truss. A second lattice web 55d is connected to the other chord 55a2 of the upper planar latticed truss and chord 55b2 of the lower planar latticed truss.

As visible in FIGS. 1b and 2b, the outer end of the single distal leg converges in the direction of the boom head structure, both in a plane parallel to the substantially horizontal pivot axis and parallel to the longitudinal axis of the boom, and to a plane perpendicular to the substantially horizontal pivot axis and parallel to the longitudinal axis of the boom.

It is also conceivable that the two chords of the upper and lower latticed truss of the single distal leg are essentially parallel and do not converge in the plane parallel to the substantially horizontal pivot axis and to the longitudinal axis of the boom.

The joint structure 54 is shown in detail in FIG. 2c. Here, the joint structure comprises join chords 54a1 and 54a2 that join the chords 55a1 and 55a2 of the single distal leg respectively. Not visible are join chords adjoining the other chords 55b1 and 55b2 of the single distal leg. In addition, transversal elements 54c are provided for structural stability, parallel to a plane defined by the substantially horizontal pivot axis and the longitudinal axis of the boom. It is noticed that such transversal elements 54c are only visible in an upper plane, but are also provided in a lower plane. The transversal elements adjoin the upper and lower planar latticed truss of the single distal leg. Furthermore, as visible in the side view of FIG. 1b and FIG. 5b, transversal elements 54d are provided for structural stability, in parallel planes perpendicular to the substantially horizontal pivot axis and parallel to the longitudinal axis of the boom. These transversal elements 54d are provided adjoining the first and second lattice webs of the single distal leg.

The proximal portion 53 of the boom is shown in detail in FIG. 2d, and partially in FIG. 4a.

The proximal portion 53 comprises a left-hand boom leg 53′ and a right-hand boom leg 53″ of equal length, extending between the joint structure 54 and the left-hand connector of the boom connection member 26a and the right-hand connector 26b of the boom connection member, respectively. The left-hand boom leg 53′ and the right-hand boom leg 53″ converge towards each other in the direction of the joint structure, forming a clearance 58 therebetween of an essentially triangular shape seen in a plane defined by the substantially horizontal pivot axis and the longitudinal axis of the boom.

In the shown embodiment, the proximal portion 53 further comprises a connection member 59 oriented parallel to the substantially horizontal pivot axis 28, connecting the two boom legs 53′, 53″ in the clearance 58 between them, to provide further structural stability.

At the inner end 51 of the boom, the boom legs 53′, 53″ are tapered to be connected to the left-hand connector 26a and the right-hand connector 26b respectively. In the detailed view of FIGS. 5a and 5b, it is visible that in this embodiment the boom legs converge to a connection element 51a′ and 51a″ provided with a hole, to be connected to the connectors via a pin.

Each of the two boom legs 53′, 53″ comprises an upper and lower planar latticed truss (53a′, 53b′; 53a″, 53b″) provided parallel to a plane defined by the substantially horizontal pivot axis and the longitudinal axis of the boom, each with two chords between which lacing elements extend. In particular, as visible in FIG. 2d, the upper planar latticed trusses 53a′ and 53a″ are shown, of the boom leg 53 and 53′ respectively. Therebelow, not visible, are lower planar latticed trusses 53b′ and 53b″.

The upper planar latticed truss 53a′ comprises two chords 53a′1 and 53a′2, between which lacing elements 53a′3 extend. The upper planar latticed truss 53a″ comprises two chords 53a″1 and 53a″2, between which lacing elements 53a″3 extend.

The lower planar latticed truss 53b″ is visible in the side view of FIG. 4a (with lower planar latticed truss 53b′ of the other boom leg therebehind).

Each of the boom legs 53′, 53″ further comprises an outside lattice web and an inside lattice web. The inside lattice webs of the left-hand and right-hand boom legs face the clearance 58 between the boom legs.

In FIG. 4a the outside lattice web 53c″ is visible, being connected to an outside chord 53a″1 of the upper planar latticed truss 53a″ and an outside chord 53b″1 of the lower planar latticed truss 53b″. “Parallel thereof is inside lattice web 53d” (indicated in FIG. 5a), being connected to an inside chord of the upper planar latticed truss and an inside chord of the lower planar latticed truss. Likewise, outside lattice web 53d′ and inside lattice web 53c′ of the left-hand boom leg 53′ are indicated.

In the shown embodiment, as in particular visible in FIG. 2c, and FIGS. 5a and 5b, at the joint structure 54 the outside chords 53a″1 and 53a′2 of the boom legs 53″ and 53′ respectively of the proximal portion 53 are aligned with the chords 55a1 and 55a2 of the distal leg 55, such that the outside lattice web of the left-hand 53′, and outside lattice web 53c″ of the right-hand boom leg 53″ join into the first lattice web 55c and second lattice web 55d of the distal leg 55.

Alternatively, as visible in FIG. 6a, the chords of the proximal portion and the cords of the single distal leg are not aligned. In the shown embodiment similar parts have been given the same reference numeral to which ‘100’ has been added.

Here, at the joint structure 154 the outside chords 153a″1 and 153a′2 of the boom legs 153″ and 153′ respectively of the proximal portion 53 are not aligned with the chords 155a1 and 155a2 of the distal leg 155.

Instead, at the joint structure 154 the width between the chords 155a1, 155a2 of the single distal leg is at least 70% of the width between the outside chords 153a″1, 153a′2 of the boom legs of the proximal portion. The joint structure 154 is shaped to overcome this difference, in that the chords 154a1 and 154a2 converge in the direction of the distal leg, and in that the transversal element 154c′ is longer than transversal element 154c″. In the side view of FIG. 6b, no difference between the embodiments is visible.

In FIGS. 7a and 7b, yet a second alternative embodiment of a boom of a hoisting crane according to the invention is shown. In the shown embodiment similar parts have been given the same reference numeral to which ‘200’ has been added.

Here, the single distal leg 255 is composed of interconnected parts 255′, 255″, 255″. By providing or removing such parts, the length of the boom can easily be elongated or shortened, respectively. This is advantageous in that is provides an increased versatility to the crane. The cross section of parts 255′ and 255″ is constant, i.e. it does not converge in any direction. Only the part 255′″ converges in the direction of the boom head structure 260.

It is noted that the hollow box structure of parts 255′, 255″ and 255′″ may also include a transverse girder at the head ends of the parts.

1. A hoisting crane for use on an offshore vessel comprising:
a base structure adapted to be mounted on the vessel;
a superstructure mounted to the base structure, being provided with:
a top cable guide at a top thereof; and
a boom connection member comprising a left-hand connector and a right-hand hand connector at a mutual distance of each other, together defining a horizontal pivot axis;
a boom having a longitudinal axis and a length of 80-200 meters; wherein the boom has an inner end connected to the left-hand connector and right-hand connector of the boom connection member, so that the boom can be pivoted up and down about the horizontal pivot axis which is perpendicular to the longitudinal axis of a boom;
a boom head structure provided at a tip end of the boom;
a luffing device for pivoting the boom up and down, comprising a luffing winch and a variable length luffing system, the variable length luffing system extending from the luffing winch via the top cable guide to the boom head structure; and
a hoisting device for hoisting a load, comprising a hoisting winch and an associated hoisting cable, the hoisting cable extending from the hoisting winch to a main hoist cable guide on the boom head structure,
wherein the boom comprises a proximal portion connected to the boom connection member, formed integral via a joint structure with a single distal leg, wherein the length of the distal leg between the joint and the boom head structure exceeds 30 meters;
wherein the proximal portion of the boom comprises a left-hand boom leg and a right-hand boom leg of equal length extending between the joint structure and the left-hand connector of the boom connection member and the right-hand connector of the boom connection member, respectively, such that the left-hand boom leg and the right-hand boom leg converge towards each other in the direction of the joint structure, forming a clearance therebetween of an essentially triangular shape seen in a plane defined by the substantially horizontal pivot axis and the longitudinal axis of the boom,
wherein each of the two boom legs comprises a hollow box structure with a top and bottom face and an outer and an inner side face, wherein the inner side faces of the left-hand and right-hand boom legs face the clearance between the boom legs,
wherein the single distal leg has a hollow box structure with a top and bottom face and two side faces, and
wherein at the joint structure the width between the side faces of the single distal leg is at least 70% of the width between the outer side faces of the boom legs of the proximal portion.

2. The hoisting crane according to claim 1, wherein the ratio between the proximal portion and the distal leg is 1:1 and 3:1.

3. The hoisting crane according to claim 1, wherein the hollow box structure comprises a planar latticed truss at the top and/or bottom face, and a lattice web at the side face.

4. The hoisting crane according to claim 1, wherein at the joint structure the outer side faces of the boom legs of the proximal portion are aligned with the side faces of the distal leg.

5. The hoisting crane according to claim 1, wherein the hollow box structure of the single distal leg comprises:
an upper and lower planar latticed truss provided parallel to a plane defined by the substantially horizontal pivot axis and the longitudinal axis of the boom, each of the upper and lower planar latticed trusses having two chords between which lacing elements extend; and
a first and second lattice web, each of the first and second lattice webs being connected to one of the chords of the upper planar latticed truss and one of the chords of the lower planar latticed truss.

6. The hoisting crane according to claim 1, wherein the side faces of the single distal leg are essentially parallel.

7. The hoisting crane according to claim 1, wherein the hollow box structure of each of the two boom legs comprises:
an upper and lower planar latticed truss provided parallel to a plane defined by the substantially horizontal pivot axis and the longitudinal axis of the boom, each of the upper and lower planar latticed trusses having two chords between which lacing elements extend; and
an outside and an inside lattice web,
wherein the inside lattice webs of the left-hand and right-hand boom legs face the clearance between the boom legs, and
wherein the outside lattice web is connected to an outside chord of the upper planar latticed truss and an outside chord of the lower planar latticed truss, and the inside lattice web is connected to an inside chord of the upper planar latticed truss and an inside chord of the lower planar latticed truss.

8. The hoisting crane according to claim 1, further comprising an annular bearing structure, wherein the superstructure is moveably mounted to the base structure via the bearing structure to allow the superstructure with the boom connection member to revolve about a vertical revolving axis relative to the base structure.

9. The hoisting crane according to claim 1, wherein the proximal portion further comprises one or more connection members oriented parallel to the substantially horizontal pivot axis, connecting the two boom legs in the clearance between them.

10. The hoisting crane according to claim 1, wherein the luffing winch is mounted to a foot portion of the superstructure, opposite the boom connection member.

11. The hoisting crane according to claim 1, wherein the hoisting crane further comprising a whiphoist, mounted to the boom head structure.

12. The hoisting crane according to claim 1, wherein the superstructure comprises an open frame.

13. An offshore vessel for use in handling of one or more offshore wind turbine components, wherein the vessel is provided with the hoisting crane according to claim 1.

14. The offshore vessel according to claim 13, wherein the vessel is a marine jack-up type crane vessel comprising:
a hull with a deck;
a plurality of jack-up legs, each of the plurality of jack-up legs being movable in a vertical direction with respect to the hull;
a plurality of generally vertical leg openings extending through the hull, and wherein the jack-up legs extend through the hull via one of said vertical leg openings; and
a plurality of jack-up housings provided on deck and housing the vertical leg openings, and wherein the base structure is formed integral with a jack-up housing.

15. A method for hoisting an offshore wind turbine component, comprising using the crane according to claim 1 to hoist the offshore wind turbine component.

16. The hoisting crane according to claim 1, wherein the ratio between the proximal portion and the distal leg is between 1:1 and 2:1.

17. A method for hoisting an offshore wind turbine component comprising using the vessel according to claim 13 to hoist the offshore wind turbine component.

18. The hoisting crane according to claim 2, wherein the hollow box structure comprises a planar latticed truss at the top and/or bottom face, and a lattice web at the side face.
